(19) United States
(12) Patent Application Publication
(10) Pub. No.: US 2021/0083546 A1
(43) Pub. Date: Mar. 18, 2021

(54) PROPULSION SYSTEM FOR A MOTOR VEHICLE

(71) Applicant: GM Global Technology Operations LLC, Detroit, MI (US)

(72) Inventors: Pete R. Garcia, North Branch, MI (US); Boris Burgman, Oak Park, MI (US); Chi Teck Lee, Novi, MI (US); Rebecca K. Risko Cattell, Ferndale, MI (US); Patrick S. Portell, Clarkston, MI (US)

(21) Appl. No.: 16/570,584

(22) Filed: Sep. 13, 2019

(51) Int. Cl. H02K 5/173; F16C 21/00; F16H 57/021

(52) U.S. Cl. CPC H02K 5/1737; F16H 2057/0216; F16H 57/021; F16C 21/00

(57) ABSTRACT

A propulsion system for a motor vehicle includes a casing having first and second housing portions cooperating with one another to define a cavity. The propulsion system further includes an electric motor disposed within the cavity. A support mechanism is attached to at least one of the first and second housing portions. The support mechanism includes a first side that faces the first housing portion and a second side that faces the second housing portion and is disposed within the cavity. Bearing seats are formed in the first housing portion, the second housing portion, and the second side of the support mechanism. Bearings are engaged with an associated one of the bearing seats and are configured to rotatably support the input member, the layshaft, and the output member in a fixed-free bearing arrangement. The first side of the support mechanism is free of the bearing seats and the bearings.

### INTRODUCTION

The present disclosure relates to a geartrain arrangement for a propulsion system of a motor vehicle, and more particularly to a propulsion system with a fixed-free bearing arrangement that improves fuel economy, reduces assembly cycle time, decreases associated tooling costs, and lowers noise, vibration, and harshness (NVH) levels.

Modern hybrid electric vehicles (HEVs) and electric vehicles (EVs) have electric drive units for reducing or eliminating fuel consumption. The electric drive unit can include a casing that encloses an electric motor and a complex arrangement of gears and shafts. These electric drive units may include fixed bearings that support the shafts directly on the outer casing. The bearings may include multiple bearing plates or other devices for supporting both radial loads and thrust loads in each shaft. Because the casing can be the outermost structure of the electric drive unit, the bearings can transmit loads from the shafts directly to the casing, which can increase NVH levels. In addition, the radial loads and the thrust loads within the bearings can result in friction losses while free spinning. The size and number of bearing components can reduce available packaging space within the casing and add to the overall mass of the vehicle. Furthermore, multiple fixtures or other devices may be required to control axial tolerances of shafts rotatably supported by these bearings.

Thus, while current electric drive units achieve their intended purpose, there is a need for a new and improved electric drive unit and method of manufacturing same that addresses these issues.

### SUMMARY

According to several aspects, a propulsion system for a motor vehicle is provided. The propulsion system includes a casing having a first housing portion and a second housing portion cooperating with one another to define a cavity. The propulsion system further includes an electric motor disposed within the cavity. The propulsion system further includes an input member operably engaged with the motor to receive torque from the motor and rotate about a first longitudinal axis. The propulsion system further includes a layshaft operably engaged with the input member to receive torque from the input member and rotate about a second longitudinal axis. The propulsion system further includes an output member operably engaged with the layshaft to receive torque from the layshaft and rotate about a third longitudinal axis. The propulsion system further includes a support mechanism attached to at least one of the first and second housing portions. The support mechanism includes a first side that faces the first housing portion and a second side that faces the second housing portion and is disposed within the cavity. The propulsion system further includes a plurality of bearing seats formed in the first housing portion, the second housing portion, and the second side of the support mechanism. The propulsion system further includes a plurality of bearings engaged with an associated one of the bearing seats to rotatably support the input member, the layshaft, and the output member in a fixed-free bearing arrangement. The first side of the support mechanism is free of the bearing seats and the bearings.

In one aspect, the fixed-free bearing arrangement includes a first fixed bearing that engages an associated bearing seat in the second housing portion for axially and radially supporting the input member relative to the first longitudinal axis. In addition, the fixed-free bearing arrangement further includes a first free bearing that engages an associated bearing seat in the support mechanism for radially supporting the input member relative to the first longitudinal axis.

In another aspect, the first fixed bearing is in the form of a ball bearing, which includes an outer race attached to the associated bearing seat of the second housing portion by a press-fit or a slip-fit. The ball bearing further includes a snap ring that retains the outer race in the associated bearing seat of the second housing portion, where the snap ring is a tapered-section snap ring or a constant-section snap ring. The ball bearing further includes an inner race attached to the input member by at least one of a press-fit and a slip-fit. The ball bearing further includes a threaded fastener that retains the inner race on the input member. The ball bearing further includes a plurality of spherical ball elements separating the outer and inner races from one another.

In another aspect, the first free bearing is in the form of a roller bearing or a ball bearing. Each bearing includes an outer race attached to the associated bearing seat of the support mechanism by a press-fit. In addition, each bearing further includes an axial retention mechanism that retains the outer race in the associated bearing seat of the support mechanism, and each bearing further includes an inner race formed on the input member. Each bearing further includes a plurality of cylindrical roller elements separating the outer and inner races from one another.

In another aspect, the fixed-free bearing arrangement includes a second fixed bearing that engages an associated bearing seat in the support mechanism for axially and radially supporting the layshaft relative to the second longitudinal axis. In addition, the fixed-free bearing arrangement also includes a second free bearing that engages an associated bearing seat in the first housing portion for radially supporting the layshaft relative to the second longitudinal axis.

In another aspect, the second fixed bearing is in the form of a ball bearing, which includes an outer race attached to the associated bearing seat of the support mechanism by a press-fit or a slip-fit. The ball bearing further includes a snap ring that retains the outer race in the associated bearing seat of the support mechanism, where the snap ring is a tapered-section snap ring or a constant-section snap ring. The ball bearing further includes an inner race attached to the layshaft by at least one of a press-fit and a slip-fit. The ball bearing further includes a threaded fastener that retains the inner race on the layshaft. The ball bearing further includes a plurality of spherical ball elements separating the outer and inner races from one another.

In another aspect, the second free bearing is in the form of a roller bearing or a ball bearing. Each bearing includes an outer race attached to the associated bearing seat of the first housing portion by a press-fit. In addition, each bearing also includes an axial retention mechanism that retains the outer race in the associated bearing seat of the first housing portion. Each bearing further includes an inner race formed on the layshaft. Each bearing further includes a plurality of cylindrical roller elements separating the outer and inner races from one another.

In another aspect, the fixed-free bearing arrangement includes a third fixed bearing that engages an associated bearing seat in the support mechanism for axially and radially supporting the output member relative to the third longitudinal axis. Furthermore, the fixed-free bearing arrangement also includes a third free bearing that engages an associated bearing seat in the first housing portion for radially supporting the output member relative to the third longitudinal axis.

In another aspect, the third fixed bearing is in the form of a ball bearing, which includes an outer race attached to the associated bearing seat of the support mechanism by a press-fit or a slip-fit. The ball bearing further includes a snap ring that retains the outer race in the associated bearing seat of the support mechanism, where the snap ring is a tapered-section snap ring or a constant-section snap ring. The ball bearing further includes an inner race attached to the output member by at least one of a press-fit and a slip-fit. The ball bearing further includes a threaded fastener that retains the inner race on the output member. The ball bearing further includes a plurality of spherical ball elements separating the outer and inner races from one another.

In another aspect, the third free bearing is in the form of a roller bearing or a ball bearing. Each bearing includes an outer race attached to the associated bearing seat of the first housing portion by a press-fit. In addition, each bearing also includes an axial retention mechanism that retains the outer race in the associated bearing seat of the first housing portion. Each bearing further includes an inner race formed on the output member. Each bearing further includes a plurality of cylindrical roller elements separating the outer and inner races from one another.

In another aspect, the support mechanism includes a plate having a plurality of ribs configured to reinforce the plate, and the support mechanism further includes a peripheral edge attached to the first and second housing portions.

According to several aspects, a propulsion system for a motor vehicle is provided. The propulsion system includes a casing having a first housing portion and a second housing portion cooperating with one another to define a cavity. The propulsion system further includes an electric motor disposed within the cavity. The propulsion system further includes an input member operably engaged with the motor to receive torque from the motor and rotate about a first longitudinal axis. The propulsion system further includes a layshaft operably engaged with the input member to receive torque from the input member and rotate about a second longitudinal axis. The propulsion system further includes an output member operably engaged with the layshaft to receive torque from the layshaft and rotate about a third longitudinal axis. The propulsion system further includes a support mechanism attached to at least one of the first and second housing portions. The support mechanism includes a first side that faces the first housing portion and a second side that faces the second housing portion and is disposed within the cavity. The propulsion system further includes a plurality of bearing seats formed in the first housing portion, the second housing portion, and the second side of the support mechanism. The propulsion system further includes a plurality of bearings engaged with an associated one of the bearing seats to rotatably support the input member, the layshaft, and the output member in a fixed-free bearing arrangement. The first side of the support mechanism is free of the bearings and the bearing seats. Furthermore, the propulsion system also includes a plurality of pilot holes formed in an associated one of the first housing portion, the second housing portion, and the support mechanism. The pilot holes are disposed relative to the bearing supports such that alignment of the pilot holes with one another disposes the input member relative to the layshaft for operably engaging the input member with the layshaft. The propulsion system further includes a guide pin configured to be received in the pilot holes when the pilot holes are aligned with one another.

In one aspect, the bearings include a first fixed bearing that engages an associated bearing seat in the second housing portion for axially and radially supporting the input member relative to the first longitudinal axis. In addition, the bearings also include a second fixed bearing that engages an associated bearing seat in the support mechanism for axially and radially supporting the layshaft relative to the second longitudinal axis. The input member and the layshaft are operably engaged to one another, in response to the pilot holes of the second housing portion and the support mechanism being aligned with one another.

In another aspect, the bearings further include a first free bearing that engages an associated bearing seat in the support mechanism for radially supporting the input member on the support mechanism, in response to the pilot holes of the second housing portion and the support mechanism being aligned with one another.

In another aspect, the bearings further include a second free bearing that engages an associated bearing seat in the first housing portion for radially supporting the layshaft on the first housing portion, in response to the pilot holes of the first housing portion and the support mechanism being aligned with one another.

In another aspect, the bearings further include a third fixed bearing that engages an associated bearing seat in the support mechanism for axially and radially supporting the output member on the support mechanism. In addition, the bearings further include a third free bearing that engages an associated bearing seat in the first housing portion mechanism for radially supporting the output member on the first housing portion, in response to the pilot holes of the first housing portion and the support mechanism being aligned with one another.

According to several aspects, a method for assembling a propulsion system for a motor vehicle is provided. The propulsion system includes a casing that has a first housing portion and a second housing portion. The propulsion system further includes an electric motor, an input member, a layshaft, an output member, a support mechanism, a plurality of bearing seats, and a guide pin. The support mechanism has a first side facing the first housing portion and a second side facing the second housing portion. The method includes the step of forming the bearing seats in the first housing portion, the second housing portion, and one side of the support mechanism, with the other side of the support mechanism being free of the bearing seats. The method further includes forming the pilot holes in the first housing portion, the second housing portion, and the support mechanism relative to the bearing seats. The method further includes aligning the pilot holes of the first housing portion, the support mechanism, and the second housing portion with one another. In response to aligning the pilot holes with one another, a first fixed bearing radially and axially supports the input member on the second housing portion such that the input member is operably engaged with the electric motor to receive torque from the motor and rotate about a first longitudinal axis. In further response to aligning the pilot holes with one another, a second fixed bearing radially and axially supports the layshaft on the support mechanism such that the layshaft is operably engaged with the input member receive torque from the input member and rotate about a second longitudinal axis. Still in further response to aligning the pilot holes with one another, a third fixed bearing radially and axially supports the output member on the support mechanism such that the output member is operably engaged with the layshaft to receive torque from the layshaft and rotate about a third longitudinal axis. The method further includes connecting the first and second housing portions to one another to define a cavity in which the bearing seats of the support mechanism are disposed.

In one aspect, the method further includes forming a plurality of inner races on at least one of the input member, the layshaft, and the output member.

In another aspect, the method further includes attaching a plurality of outer races to an associated one of the bearing seats, using at least one of a press-fit, a tapered-section snap ring, and a constant-section snap ring.

In another aspect, in response to the pilot holes being aligned with one another, a first free bearing radially supports the input member on the support mechanism. In addition, a second free bearing radially supports the layshaft on the first housing portion. A third free bearing radially supports the output member on the first housing portion.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic view of one embodiment of motor vehicle having a propulsion system including a front electric drive unit coupled to a front axle and a rear electric drive unit coupled to a rear axle.

FIG. 2 is a perspective view of another embodiment of the front electric drive unit of FIG. 1.

FIG. 3 is a cross-sectional view of the electric drive unit of FIG. 2, illustrating the electric drive unit having a casing and a support structure.

FIG. 4 is an end view of the support structure of FIG. 3.

FIG. 5 is a flow chart of a method of assembling the propulsion unit of FIG. 1.

### DETAILED DESCRIPTION

The following description is merely exemplary in nature and is not intended to limit the present disclosure, application, or uses.

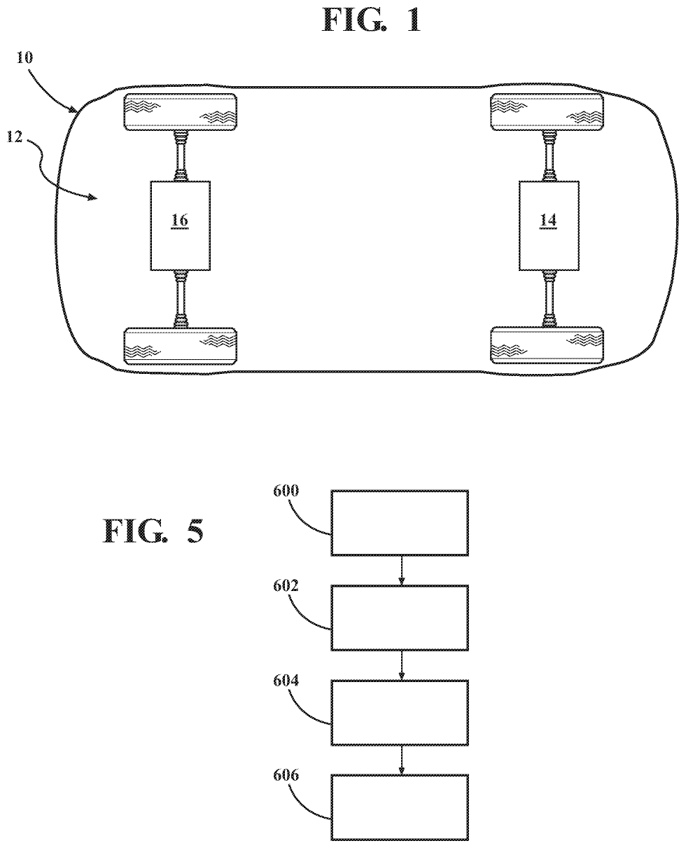

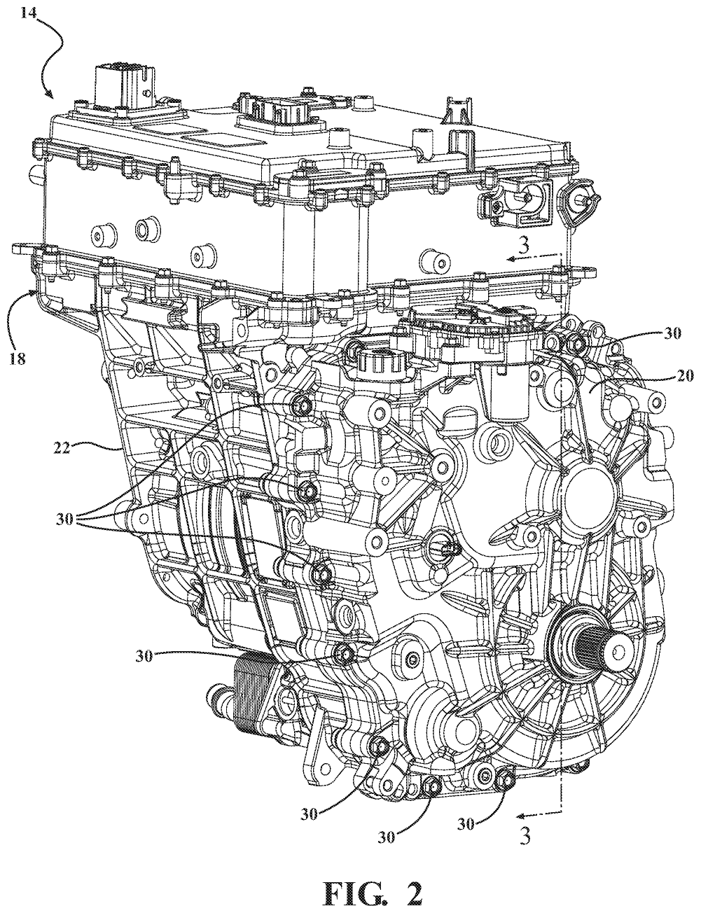

Referring to FIG. 1, there is generally illustrated a motor vehicle 10 having a propulsion system 12 or powertrain including a front electric drive unit 14 for driving a front axle and a rear electric drive unit 16 for driving a rear axle. While the front and rear electric drive units 14, 16 in this example have the same components as one another, the description is directed to only the front electric drive unit 14. However, it is contemplated that the front and rear electric drive units 14, 16 may not have the same components arranged in the same positions relative to one another. In other embodiments, the front and rear electric drive units may be different from one another to, for example, accommodate different crush zones or meet other packaging requirements for the associated ends of the vehicle. Furthermore, other embodiments of the propulsion system may include only one electric drive unit that drives both axles.

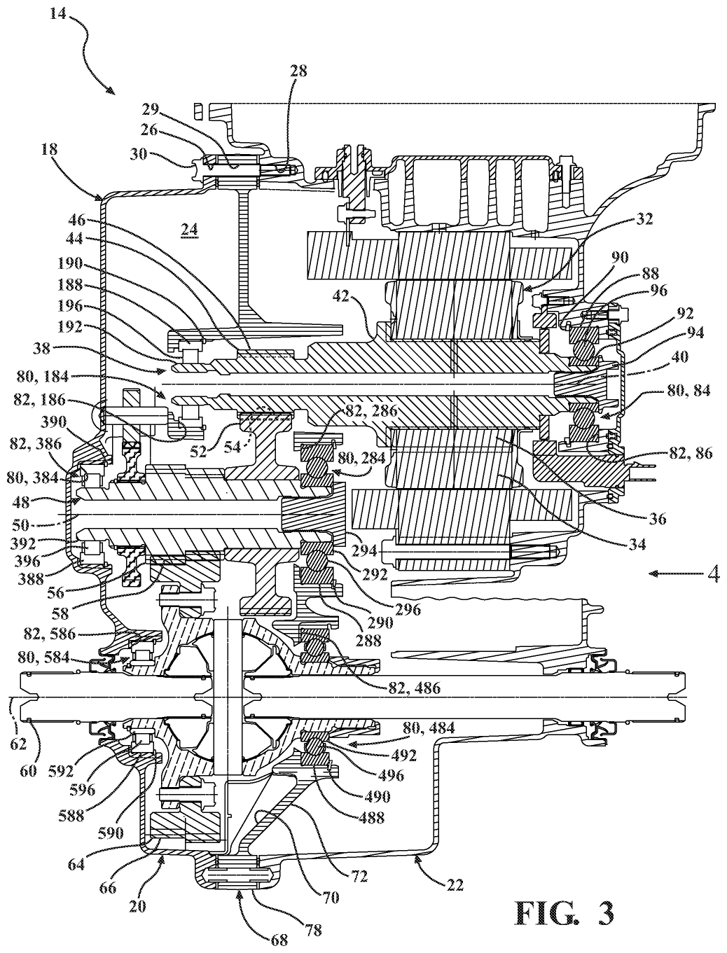

Referring to FIG. 3, the electric drive unit 14 includes a casing 18 formed from a first housing portion 20 and a second housing portion 22 that cooperate with one another to define a cavity 24. The first housing portion 20 forms one or more fastener holes 26, and the second housing portion 22 forms one or more fastener holes 28. The fastener holes 26, 28 of the first and second housing portions 20, 22 are configured to be aligned with one another, such that bolt fasteners 30 can be inserted into the aligned fastener holes 26, 28 to attach the first and second housing portions 20, 22 to one another.

The electric drive unit 14 further includes an electric motor 32 disposed within the cavity 24. In this example, the electric motor 32 may be an inductor motor having a stator 34 and a rotor 36. The rotor 36 may include a series of conducting bars that are short circuited by conductive end rings. The stator 34 may be configured to receive 3-phase AC power input, and the 3-phase alternating current in the coils produces a rotating magnetic field, which then induces current on the conducting bars of the rotor 36 to make it turn. The speed of the electric motor is proportional to the frequency of the AC power supply. It is contemplated that the electric drive unit can include any suitable electric motor.

The electric drive unit 14 is in the form of a parallel shaft gearbox with each gear stage reducing speed and increasing torque. More specifically, the electric drive unit 14 includes an input member 38 operably engaged with the motor 32 to receive torque from the motor 32 and rotate about a first longitudinal axis 40. In this example, the input member 38 includes an input shaft 42 operably engaged with the rotor 36 to receive torque from the rotor 36. The input shaft 42 further includes a pinion gear 44 having a plurality of teeth 46.

The electric drive unit 14 further includes a layshaft 48 operably engaged with the input member 38 to receive torque from the input member 38 and rotate about a second longitudinal axis 50. The layshaft 48 may be a first speed reduction layshaft including a driven gear 52 with a plurality of teeth 54 meshed with the teeth 46 on pinion gear 44 of the input shaft 42. The driven gear 52 has more teeth 54 than the pinion gear 44 has teeth 46. As but one example, the pinion gear 44 may be in the form of a 13-tooth pinion gear meshed with a 65-tooth driven gear 52 to achieve a reduction of 5:1, which decreases speed at this gear stage to one-fifth the input speed and increases torque by a factor of five before subtracting out losses. It is contemplated that the pinion gear 44 and the driven gear 52 can have any number of teeth to provide a different gear reduction at this gear set stage. The layshaft 48 further includes a drive gear 56 having a plurality of teeth 58.

The electric drive unit 14 further includes an output member 60 operably engaged with the layshaft 48 to receive torque from the layshaft 48 and rotate about a third longitudinal axis 62. Continuing with the previous example, the output member 60 may be a second speed reduction layshaft including a driven gear 64 with a plurality of teeth 66 meshed with the teeth 58 on the drive gear 56 on the layshaft 48. The driven gear 64 may have more teeth 66 than the drive gear 56 has teeth 58. In this example, the driven gear 64 of the output member 60 and the drive gear 56 of the layshaft 48 can be configured to provide a reduction of 4:1, which decreases speed at this gear stage to one-fourth the input speed and also increases torque by a factor of 4 before subtracting out losses. It is contemplated that the drive gear 56 and the driven gear 64 can have any number of teeth to provide the electric drive unit 14 with other gear ratios at this gear set stage. The total gear reduction is determined by multiplying each individual reduction from each gear stage. In the present example, the electric drive unit having 5:1 and 4:1 gear sets provides a total gear ratio of 20:1. This total gear ratio would reduce an electric motor speed from 3,450 RPM to 172.5 RPM, and a 10 lb.-in electric motor torque would be increased to 200 lb-in before subtracting energy losses. It is contemplated that the electric drive unit can have any number of shafts with any suitable total gear ratio.

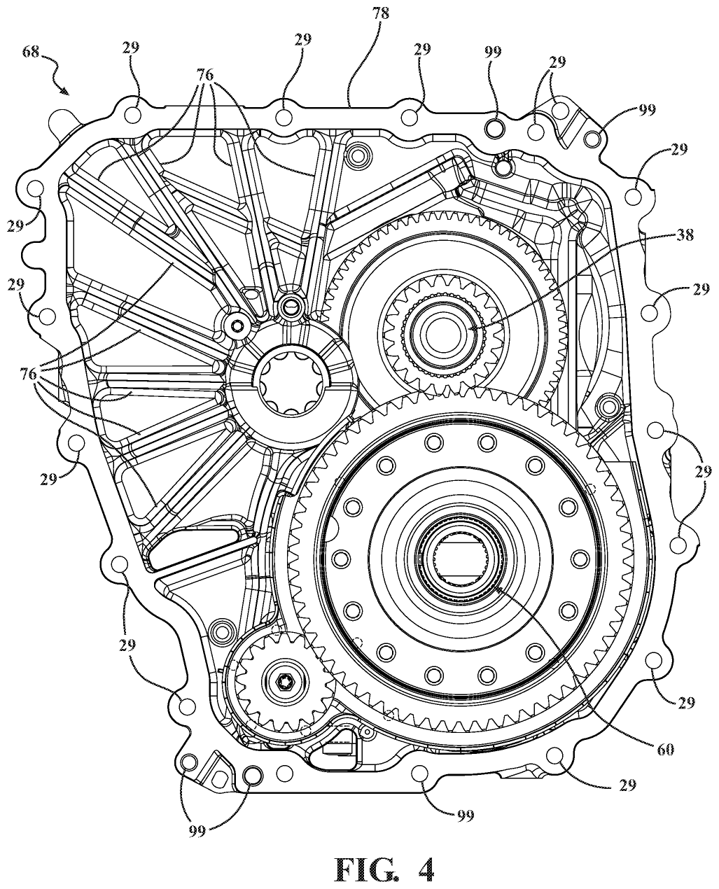

The electric drive unit 14 further includes a support mechanism 68 attached directly to at least one of the first and second housing portions 20, 22. While the support mechanism 68 in this example is attached to both the first and second housing portions 20, 22, it is contemplated that support mechanism can be attached directly or indirectly to only one or both of the housing portions 20, 22. The support mechanism 68 includes a first side 70 that faces the first housing portion 20. The support mechanism 68 further includes a second side 72 that faces the second housing portion 22 and is disposed within the cavity 24. In this example, the support mechanism 68 is a plate 74 (FIG. 4) having a plurality of ribs 76 configured to reinforce the plate 74 and a peripheral edge 78 attached to the first and second housing portions 20, 22 by the bolt fasteners 30.

The electric drive unit 14 further includes a plurality of bearing seats 80 formed in the first housing portion 20, the second housing portion 22, and the second side 72 of the support mechanism 68. In addition, the electric drive unit 14 further includes a plurality of bearings 82 engaged with an associated one of the bearing seats 80 and configured to rotatably support the input member 38, the layshaft 48, and the output member 60 in a fixed-free bearing arrangement 84. The first side 70 of the support mechanism 68 is free of the bearings 82 and the bearing seats 80. Because the bearing seats are formed in only the second side of the support mechanism, the support mechanism can remain in one fixture when all the bearing seats are formed in the support mechanism. This can reduce accumulation of tolerance associated with re-positioning the work piece within the same fixture or a new fixture to form all of the bearing seats. The ribs 76 in the plate may extend radially from one or more bearing seats to reinforce the plate.

The fixed-free bearing arrangement includes one fixed bearing and one free bearing for each one of the input member 38, the layshaft 48, and the output member 60, as described in detail below. While the fixed bearings support both radial loads and thrust or axial loads, the free bearings support only radial loads. Put another way, the free bearings do not support thrust or axial loads, such that the free bearings do not transmit these loads to the bearing seat 80. As described in detail below, the fixed bearings are attached to the support mechanism 68 within the cavity 24 of the casing 18, such that noise, vibration, and harshness may be damped within the cavity 24 or support mechanism 68 before being transmitted through the outer casing 18.

More specifically, the fixed-free bearing arrangement 84 rotatably supports the input member 38 on a first fixed bearing 84, which engages an associated bearing seat 86 in the second housing portion 22 to axially and radially support the input member 38 relative to the first longitudinal axis 40. In this example, the first fixed bearing 84 is in the form of a ball bearing 87, which includes an outer race 88 attached to the associated bearing seat 86 of the second housing portion 22 by a press-fit or a slip-fit. The ball bearing 85 further includes a snap ring 90 that retains the outer race 88 in the associated bearing seat 86 of the second housing portion 22, where the snap ring 90 is in the form of a tapered-section or a constant-section snap ring. In addition, the ball bearing 85 also includes an inner race 92 attached to the input member 38 by at least one of a press-fit and a slip-fit, with a threaded fastener 94 retaining the inner race 92 on the input member 38. The ball bearing 85 further includes a plurality of spherical ball elements 96 separating the outer and inner races 88, 92 from one another.

The fixed-free bearing arrangement 84 further rotatably supports the input member 38 on a first free bearing 184, which engages an associated bearing seat 186 in the support mechanism 68 to radially support the input member 38 relative to the first longitudinal axis 40. The first free bearing 184 can be a roller bearing 187 or a ball bearing. The roller bearing 187 includes an outer race 188 attached to the associated bearing seat 186 of the support mechanism 68 by a press-fit. The roller bearing 187 further includes an axial retention mechanism 190 that retains the outer race 188 in the associated bearing seat 186 of the support mechanism 68. Examples of the axial retention mechanism 190 can include a snap ring or in-cavity swaging features. However, it is contemplated that the fixed free bearing arrangement can have any suitable axial retention mechanisms. In addition, the roller bearing 187 also includes an inner race 192 formed on the outer diameter surface of the input member 38, such that the roller bearing 187 supports only radial loads in the input member 38 without transmitting any axial loads from the input member 38 to the support mechanism 68. The roller bearing 187 further includes a plurality of cylindrical roller elements 196 separating the outer and inner races 188, 192 from one another. It is contemplated that the ball bearing can be similar to the roller bearing and have the same components associated with the roller bearing as described above.

The fixed-free bearing arrangement 84 rotatably supports the layshaft 48 on a second fixed bearing 284, which engages an associated bearing seat 286 in the support mechanism 68 to axially and radially support the layshaft 48 relative to the second longitudinal axis 50. In this example, the second fixed bearing 284 is in the form of a ball bearing 287, which includes an outer race 288 attached to the associated bearing seat 286 of the support mechanism 68 by a press-fit or a slip-fit. The ball bearing 287 further includes a snap ring 290 that retains the outer race 288 in the associated bearing seat 286 of the support mechanism 68, where the snap ring 290 is in the form of a tapered-section or a constant-section snap ring. The ball bearing 287 further includes an inner race 292 attached to the layshaft 48 by at least one of a press-fit and a slip-fit. The ball bearing 287 further includes a threaded fastener 294 that retains the inner race 292 on the layshaft 48. The ball bearing 287 further includes a plurality of spherical ball elements 296 separating the outer and inner races 288, 292 from one another. Because the second fixed bearing 284 axially supports the layshaft 48 on the support mechanism 68 within the cavity 24, the axial load in the layshaft 48 is damped by the support mechanism 68 and the cavity 24 before it is transmitted through the outer casing 18.

The fixed-free bearing arrangement 84 further rotatably supports the layshaft 48 on a second free bearing 384, which engages an associated bearing seat 386 in the first housing portion 20 to radially support the layshaft 48 relative to the second longitudinal axis 50. The second free bearing 384 can be a roller bearing 387 or a ball bearing. The roller bearing 387 includes an outer race 388 attached to the associated bearing seat 386 of the first housing portion 20 by a press-fit. In addition, the roller bearing 387 also includes an axial retention mechanism 390 that retains the outer race 388 in the associated bearing seat 386 of the first housing portion 20. Examples of the axial retention mechanism 190 can include a snap ring or in-cavity swaging features. However, it is contemplated that the fixed free bearing arrangement can have any suitable axial retention mechanisms. The roller bearing 387 further includes an inner race 392 formed on the outer diameter surface of the layshaft 48, such that the roller bearing 387 supports only radial loads in the layshaft 48 without transmitting any axial loads from the layshaft 48 to the first housing portion 20. The roller bearing 387 further includes a plurality of cylindrical roller elements 396 separating the outer and inner races 388, 392 from one another. The ball bearing can be similar to the roller bearing and have the same components associated with the roller bearing as described above.

The fixed-free bearing arrangement 84 rotatably supports the output member 60 on a third fixed bearing 484, which engages an associated bearing seat 486 in the support mechanism 68 to axially and radially support the output member 60 relative to the third longitudinal axis 62. In this example, the third fixed bearing 484 is in the form of a ball bearing 487, which includes an outer race 488 attached to the associated bearing seat 486 of the support mechanism by a press-fit or a slip-fit. The ball bearing 487 further includes a snap ring 490 that retains the outer race 488 in the associated bearing seat 486 of the support mechanism 68, with the snap ring 490 being in the form of a tapered-section or a constant-section snap ring. The ball bearing 487 further includes an inner race 492 attached to the output member 60 by at least one of a press-fit and a slip-fit. The ball bearing 487 further includes a threaded fastener 494 that retains the inner race 492 on the output member 60. The ball bearing 487 further includes a plurality of spherical ball elements 496 separating the outer and inner races 488, 492 from one another. Because the third fixed bearing 484 axially supports the output member 60 on the support mechanism 68 within the cavity 24, the axial load in the output member 60 is damped by the support mechanism 68 and the cavity 24 before it is transmitted through the outer casing 18.

The fixed-free bearing arrangement 84 further rotatably supports the output member 60 on a third free bearing 584, which engages an associated bearing seat 586 in the first housing portion 20 to radially support the output member 60 relative to the third longitudinal axis 62. The third free bearing 584 can be a roller bearing 587 or a ball bearing. The roller bearing 587 includes an outer race 588 attached to the associated bearing seat 586 of the first housing portion 20 by a press-fit. The roller bearing 587 may further include an axial retention mechanism 590 that retains the outer race 588 in the associated bearing seat 586 of the first housing portion 20. Examples of the axial retention mechanism 590 can include a snap ring or in-cavity swaging features. However, it is contemplated that the fixed free bearing arrangement can have any suitable axial retention mechanisms. The roller bearing 587 further includes an inner race 592 formed on the outer diameter surface of the output member, such that the roller bearing 587 supports only radial loads in the output member 60 without transmitting any axial loads from the output member 60 to the first housing portion 20. Examples of the inner race can include the outer diameter surface of the output member or a sleeve attached to the outer diameter surface of the output member. The roller bearing 587 further includes a plurality of cylindrical roller elements 596 separating the outer and inner races 588, 592 from one another. The ball bearing can be similar to the roller bearing and have the same components associated with the roller bearing as described above.

The electric drive unit 14 further includes a plurality of pilot holes 97, 98, 99 formed in an associated one of the first housing portion 20, the second housing portion 22, and the support mechanism 68. The electric drive unit 14 further includes a guide pin 100 configured to be received in the pilot holes 97, 98, 99 when the pilot holes are aligned with one another. The pilot holes 97, 98, 99 are disposed relative to the bearing supports such that the input member 38 is disposed relative to the layshaft 48 for operably engaging the input member 38 and the layshaft 48 to one another in response to the pilot holes 98, 99 of the support structure 68 and the second housing portion 22 being aligned with one another. In addition, the input member 38 is positioned to be received within the first free bearing 184 to radially support the input member 38 on the support mechanism 68, in response to the pilot holes 98, 99 of the support mechanism 68 and the second housing portion 22 being aligned with one another. The layshaft 48 is positioned to be received within the second free bearing 384 to radially support the layshaft 48 on the first housing portion 20, in response to the pilot holes 97, 98 of the first housing portion 20 and the support mechanism 68 being aligned with one another. The output member 60 is positioned to be received within the third fixed bearing 484 to axially and radially support the output member 60 on the support mechanism 68, in response to the pilot holes 97, 98 of the first housing portion 20 and the support mechanism 68 being aligned with one another. The output member 60 is positioned to be received in the third free bearing 584 to radially support the output member 60 on the first housing portion 20, in response to the pilot holes 97, 98 of the first housing portion 20 and the support mechanism 68 being aligned with one another.

The first housing portion 20, the support mechanism 68, and the second housing portion 22 form associated fastener holes 26, 28, 29. The fastener holes 26, 28, 29 are disposed relative to the associated pilot holes 97, 98, 99, such that the fastener holes 26, 28, 29 are aligned with one another when the pilot holes 97, 98, 99 are aligned with one another. The electric drive unit further includes bolt fasteners 30 configured to be inserted into the aligned fastener holes 26, 28, 29 to connect the first housing portion 20, the support mechanism 68, and the second housing portion 22 to one another.

Referring to FIG. 5, a method for assembling the propulsion system 12 for the motor vehicle of FIG. 1 is provided. At step 600, the method begins with the step of forming the bearing seats 80 in the second side 72 of the support mechanism 68, with the other side 70 of the support mechanism 68 being free of the bearing seats 80. In particular, a blank plate may be mounted in a fixture and a CNC milling machine may be operated to bore or machine all of the bearing seats in the second side 72 of the support mechanism 68. This may reduce accumulation of tolerances associated with re-positioning the plate in the same fixture or multiple fixtures to, for example, drill bearing seats in both sides of the support mechanism. However, it is contemplated that other suitable manufacturing processes and tools may be use form the bearing seats in the support structure.

At step 602, the method includes the step of forming the pilot holes in the support mechanism relative to the bearing seats. This step may be accomplished with the plate remaining in the fixture to machine or bore the bearing seats. However, it is contemplated that the plate can be mounted in a different fixture and any suitable manufacturing process can be used to form the pilot holes. Similarly, the bearing seats are formed in one side of the first housing portion 20 facing the support mechanism 68 and one side of the second housing portion 22 facing the support mechanism 68.

At step 604, the method includes the step of aligning the pilot holes 97, 98, 99 formed in the associated first housing portion 20, the support mechanism 68, and the second housing portion 22, such that the layshaft 48 is positioned relative to the input member 38 to operably engage the layshaft 48 with the input member 38 to receive torque from the input member 38 and rotate about the second longitudinal axis 50.

In further response to the pilot holes 97, 98, 99 being aligned with one another, the first fixed bearing 84 radially and axially supports the input member 38 on the second housing portion 22. In this way, the input member 38 is operably engaged with the electric motor 32 for receiving torque from the motor 32 to rotate about the first longitudinal axis 40. More specifically, the outer race 88 is attached to the bearing seat 86 using at least one of a press-fit, a tapered fit, and the snap ring 90. The inner race 92 is attached to the input member 38 using at least one of a press-fit, a tapered fit, and the snap ring 90. Spherical ball elements 96 separate the outer and inner races from one another. In addition, the first free bearing 184 axially supports the input member 38 on the support mechanism 68. The first free bearing 184 includes the outer race 188 attached to the bearing seat 186 using at least one of a press-fit, a tapered fit, and the snap ring 90. The inner race 192 is formed on the outer diameter surface of the input member 38. Cylindrical roller elements 196 separate the outer and inner races 188, 192 from one another.

Also, in response to the pilot holes 97, 98, 99 being aligned with one another, the second fixed bearing 284 radially and axially supports the layshaft 48 on the support mechanism 68. In this way, the layshaft 48 is operably engaged with the input member 38 to receive torque from the input member 38 to rotate about the second longitudinal axis 50. More specifically, the outer race 288 is attached to an associated one of the bearing seats 286, using at least one of a press-fit, a slip-fit, a tapered-section snap ring, and the constant-section snap ring 290. The inner race 292 is attached to the layshaft 48 using at least one of a press-fit, a tapered fit, and the snap ring 290. Spherical ball elements 296 separate the outer and inner races 288, 292 from one another. In addition, the second free bearing 384 axially supports the layshaft 48 on the first housing portion 20. The inner race 392 is formed on an outer diameter surface of the layshaft 48. Cylindrical roller elements 396 separate the outer and inner races 388, 392 from one another.

In further response to the pilot holes 97, 98, 99 being aligned with one another, the third fixed bearing 484 radially and axially supports the output member 60 on the support mechanism 68. In this way, the output member 60 is operably engaged with the layshaft 48 to receive torque from the layshaft 48 to rotate about the third longitudinal axis 62. Moreover, the third free bearing 584 axially supports the output member 60 on the first housing portion 20. More specifically, the outer race 588 is attached to an associated bearing seat 586, using at least one of a press-fit, a tapered-section snap ring, and the constant-section snap ring 590. The inner race 592 is formed on the outer diameter surface of the output member 60. Cylindrical roller elements 596 separate the outer and inner races 588, 592 from one another.

At step 606, the method includes the step of connecting the first housing portion 20, the support mechanism 68 and the second housing portion 22 to one another to define the cavity 24 where the second side 72 of the support mechanism 68 with the bearing seats 80 is disposed. In this respect, only the support mechanism 68 within the cavity 24 receives thrust or axial loads from the layshaft 48 and the output member 60. Because the outer casing 18 does receive thrust loads from the layshaft and the output member 60, the electric drive unit 14 reduce NVH levels associated with same.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A propulsion system for a motor vehicle, the propulsion system comprising:
a casing having a first housing portion and a second housing portion cooperating with one another to define a cavity;
an electric motor disposed within the cavity;
an input member operably engaged with the motor for receiving torque from the motor to rotate about a first longitudinal axis;
a layshaft operably engaged with the input member for receiving torque from the input member to rotate about a second longitudinal axis;
an output member operably engaged with the layshaft for receiving torque from the layshaft to rotate about a third longitudinal axis;
a support mechanism attached to at least one of the first and second housing portions, wherein the support mechanism comprises a first side that faces the first housing portion and a second side that faces the second housing portion and is disposed within the cavity;
a plurality of bearing seats formed in the first housing portion, the second housing portion, and the second side of the support mechanism; and
a plurality of bearings engaged with an associated one of the bearing seats and configured to rotatably support the input member, the layshaft, and the output member in a fixed-free bearing arrangement;
wherein the first side of the support mechanism is free of the bearing seats and the bearings.

2. The propulsion system of claim 1 wherein the fixed-free bearing arrangement for rotatably supporting the input member comprises:
a first fixed bearing that engages an associated bearing seat in the second housing portion for axially and radially supporting the input member relative to the first longitudinal axis; and
a first free bearing that engages an associated bearing seat in the support mechanism for radially supporting the input member relative to the first longitudinal axis.

3. The propulsion system of claim 2 wherein the first fixed bearing is in the form of a ball bearing comprising:
an outer race attached to the associated bearing seat of the second housing portion by one of a press-fit and a slip-fit;
a snap ring for retaining the outer race in the associated bearing seat of the second housing portion, wherein the snap ring is one of a tapered-section snap ring and a constant-section snap ring;
an inner race attached to the input member by at least one of a press-fit and a slip-fit;
a threaded fastener for retaining the inner race on the input member; and
a plurality of spherical ball elements separating the outer and inner races from one another.

4. The propulsion system of claim 2 wherein the first free bearing is in the form of one of a roller bearing and a ball bearing, and each of the roller bearing and the ball bearing comprises:
an outer race attached to the associated bearing seat of the support mechanism by a press-fit;
an axial retention mechanism for retaining the outer race to the associated bearing seat of the support mechanism;
an inner race formed on the input member; and
a plurality of cylindrical roller elements separating the outer and inner races from one another.

5. The propulsion system of claim 2 wherein the fixed-free bearing arrangement for rotatably supporting the layshaft comprises:
a second fixed bearing that engages an associated bearing seat in the support mechanism for axially and radially supporting the layshaft relative to the second longitudinal axis; and
a second free bearing that engages an associated bearing seat in the first housing portion for radially supporting the layshaft relative to the second longitudinal axis.

6. The propulsion system of claim 5 wherein the second fixed bearing is in the form of a ball bearing comprising:
an outer race attached to the associated bearing seat of the support mechanism by one of a press-fit and a slip-fit;
a snap ring for retaining the outer race in the associated bearing seat of the support mechanism, wherein the snap ring is one of a tapered-section snap ring and a constant-section snap ring;
an inner race attached to the layshaft by at least one of a press-fit and a slip-fit;
a threaded fastener for retaining the inner race on the layshaft; and
a plurality of spherical ball elements separating the outer and inner races from one another.

7. The propulsion system of claim 5 wherein the second free bearing is in the form of one of a roller bearing and ball bearing, and each of the roller bearing and the ball bearing comprises:
an outer race attached to the associated bearing seat of the first housing portion by a press-fit;
an axial retention mechanism for retaining the outer race in the associated bearing seat of the first housing portion;
an inner race formed on the layshaft; and
a plurality of cylindrical roller elements separating the outer and inner races from one another.

8. The propulsion system of claim 5 wherein the fixed-free bearing arrangement for rotatably supporting the output member comprises:
a third fixed bearing that engages an associated bearing seat in the support mechanism for axially and radially supporting the output member relative to the third longitudinal axis; and
a third free bearing that engages an associated bearing seat in the first housing portion for radially supporting the output member relative to the third longitudinal axis.

9. The propulsion system of claim 8 wherein the third fixed bearing is in the form of one of a roller bearing and ball bearing, and each of the roller bearing and the ball bearing comprises:
an outer race attached to the associated bearing seat of the support mechanism by one of a press-fit or slip-fit;
a snap ring for retaining the outer race in the associated bearing seat of the support mechanism;
an inner race attached to the output member by at least one of a press-fit and a slip-fit;
a threaded fastener for retaining the inner race on the output member; and
a plurality of spherical ball elements separating the outer and inner races from one another

10. The propulsion system of claim 8 wherein the third free bearing is in the form of a roller bearing comprising:
an outer race attached to the associated bearing seat of the first housing portion by a press-fit;
an axial retention mechanism i.e. in-cavity swaging for retaining the outer race in the associated bearing seat of the first housing portion;
an inner race formed on the output member; and
a plurality of cylindrical roller elements separating the outer and inner races from one another.

11. The propulsion system of claim 6 wherein the support mechanism comprises a plate having a plurality of ribs configured to reinforce the plate and a peripheral edge attached to the first and second housing portions.

12. A propulsion system for a motor vehicle, the propulsion system comprising:
a casing having a first housing portion and a second housing portion cooperating with one another to define a cavity;
an electric motor disposed within the cavity;
an input member operably engaged with the motor for receiving torque from the motor to rotate about a first longitudinal axis;
a layshaft operably engaged with the input member for receiving torque from the input member to rotate about a second longitudinal axis;
an output member operably engaged with the layshaft for receiving torque from the layshaft to rotate about a third longitudinal axis;
a support mechanism attached to at least one of the first and second housing portions, wherein the support mechanism comprises a first side that faces the first housing portion and a second side that faces the second housing portion and is disposed within the cavity;
a plurality of bearing seats formed in the first housing portion, the second housing portion, and the second side of the support mechanism; and
a plurality of bearings engaged with an associated one of the bearing seats and configured to rotatably support the input member, the layshaft, and the output member in a fixed-free bearing arrangement, and wherein the first side of the support mechanism is free of the bearings and the bearing seats;
a plurality of pilot holes formed in an associated one of the first housing portion, the second housing portion, and the support mechanism, wherein the pilot holes are disposed relative to the bearing supports such that alignment of the pilot holes with one another disposes the input member relative to the layshaft for operably engaging the input member with the layshaft;
a guide pin configured to be received in the pilot holes when the pilot holes are aligned with one another.

13. The propulsion system of claim 12 wherein the plurality of bearings comprises:
a first fixed bearing that engages an associated bearing seat in the second housing portion for axially and radially supporting the input member relative to the first longitudinal axis; and
a second fixed bearing that engages an associated bearing seat in the support mechanism for axially and radially supporting the layshaft relative to the second longitudinal axis;
wherein the input member and the layshaft operably engage one another, in response to the pilot holes of the second housing portion and the support mechanism being aligned with one another.

14. The propulsion system of claim 13 wherein the plurality of bearings further comprise a first free bearing that engages an associated bearing seat in the support mechanism for radially supporting the input member on the support mechanism, in response to the pilot holes of the second housing portion and the support mechanism being aligned with one another.

15. The propulsion system of claim 14 wherein the plurality of bearings further comprise a second free bearing that engages an associated bearing seat in the first housing portion for radially supporting the layshaft on the first housing portion, in response to the pilot holes of the first housing portion and the support mechanism being aligned with one another.

16. The propulsion system of claim 15 wherein the plurality of bearings further comprise: a third fixed bearing that engages an associated bearing seat in the support mechanism for axially and radially supporting the output member on the support mechanism; and
a third free bearing that engages an associated bearing seat in the first housing portion mechanism for radially supporting the output member on the first housing portion, in response to the pilot holes of the first housing portion and the support mechanism being aligned with one another.

17. A method for assembling a propulsion system for a motor vehicle, the propulsion system including a casing that has a first housing portion and a second housing portion, the propulsion system further including an electric motor, an input member, a layshaft, an output member, a support mechanism, a plurality of bearing seats, and a guide pin, with the support mechanism having a first side facing the first housing portion and a second side facing the second housing portion, the method comprising the steps of:
forming the bearing seats in the first housing portion, the second housing portion, and the second side of the support mechanism, with the first side of the support mechanism being free of the bearing seats;
forming a plurality of pilot holes in the first housing portion, the second housing portion, and the support mechanism relative to the bearing seats;
radially and axially supporting, using a first fixed bearing, the input member on the second housing portion such that the input member is operably engaged with the electric motor for receiving torque from the motor to rotate about a first longitudinal axis;
radially and axially supporting, using a second fixed bearing, the layshaft on the support mechanism such that the layshaft is capable of rotating about a second longitudinal axis;
radially and axially supporting, using a third fixed bearing, the output member on the support mechanism such that the output member is operably engaged with the layshaft for receiving torque from the layshaft to rotate about a third longitudinal axis;
aligning the pilot holes formed in the first housing portion, the second housing portion, and the support mechanism, such that the layshaft is operably engaged with the input member for receiving torque from the input member to rotate about the second longitudinal axis; and
connecting the first and second housing portions to one another to define a cavity where the side of the support mechanism is having the bearing seats is disposed.

18. The method of claim 17 further comprising attaching a plurality of outer races to an associated one of the bearing seats, using at least one of a press-fit, a tapered-section snap ring, and a constant-section snap ring.

19. The method of claim 17 further comprising attaching a plurality of inner races to an associated one of the input member, the layshaft, and the output member, using at least one of a press-fit, a tapered-section snap ring, and a constant-section snap ring.

20. The method of claim 17 further comprising, in response to the pilot holes being aligned with one another:
radially supporting, using a first free bearing, the input member on the support mechanism;
radially supporting, using a second free bearing, the layshaft on the first housing portion;
radially supporting, using a third free bearing, the output member on the first housing portion.
